(19) United States
(12) Patent Application Publication
(10) Pub. No.: US 2026/0249892 A1
(43) Pub. Date: Aug. 27, 2026

(54) WHEELBARROW FLOOR GUARD PROTECTION APPARATUS

(71) Applicant: Hector Enrique Alfaro Fonseca, Menifee, CA (US)

(72) Inventor: Hector Enrique Alfaro Fonseca, Menifee, CA (US)

(21) Appl. No.: 19/059,583

(22) Filed: Feb. 21, 2025

Related U.S. Application Data
(60) Provisional application No. 63/614,548, filed on Dec. 23, 2023.

(51) Int. Cl. B62B 1/20; B62B 5/00

(52) U.S. Cl. CPC B62B 1/20; B62B 5/0006

(57) ABSTRACT

An apparatus for protecting floor surfaces from contact with anterior and posterior frame structures of a wheelbarrow includes a wheelbarrow nose protector attachable to the nose of the anterior frame structure forward of the wheel, the nose protector including a bumper constructed of a resilient material that is configured to provide a non-marring interface with the floor surface. The bumper of the nose protector may be coupled to a support via a pivot structure that enables the bumper to articulate in a rotational or tilting movement. Further, the apparatus includes a pair of sliders attachable to respective legs of the posterior frame structure, each slider including an auxiliary bumper configured to cover a bottom of each leg and constructed of a resilient material that is configured to provide a non-marring interface with the floor surface. The bumpers may be constructed using rubber, plastic, foam, or combinations thereof.

### REFERENCE TO RELATED APPLICATIONS

This is a non-provisional patent application claiming the priority of provisional application 63/614,548 filed Dec. 23, 2023, titled Wheelbarrow Floor Guard Protection System, which is incorporated herein by reference. The priority of the provisional patent application has been restored.

### BACKGROUND OF THE INVENTION

This invention relates generally to wheelbarrows and, more particularly, to a wheelbarrow having a floor protection system. In other words, the present invention is directed to a wheelbarrow having swivel and padding structures so that a floor or ground surface does not become marred.

A wheelbarrow is a small hand-propelled vehicle, usually with just one wheel, designed to be pushed and guided by a single person using two handles at the rear. The wheelbarrow is designed to distribute the weight of its load between the wheel and the operator, so enabling the convenient carriage of heavier and bulkier loads than would be possible were the weight carried entirely by the operator. A two-wheel type is more stable on level ground, while the almost universal one-wheel type has better maneuverability in small spaces, on planks, in water, or when tilted ground would throw the load off balance. The use of one wheel also permits greater control of the deposition of the load upon emptying. Sometimes, the wheelbarrow is used on floor surfaces which may be damaged by the conventional use of the wheelbarrow.

A wheelbarrow referred to in this document refers to a wheelbarrow of a type that includes (1) an anterior frame structure having a nose and a wheel rotatable about a wheel axis and (2) a posterior frame structure having two legs, a handle structure, and a tray.

Therefore, it would be desirable to have a wheelbarrow floor guard protection apparatus that includes a nose portion that includes a nose protection assembly having a pad so that a floor or ground surface is not damaged when the wheelbarrow is forward to dump a load. Further, it would be desirable to have a wheelbarrow floor guard protection apparatus in which the nose protection assembly includes a pivot mechanism that enables the tray and framework rearward of the nose portion to be rotated or swiveled. In addition, it would be desirable to have a wheelbarrow floor guard protection apparatus that includes padded slider members coupled to rear frame portion for protecting the floor when the wheelbarrow is at rest or slides.

### SUMMARY OF THE INVENTION

Accordingly, an apparatus for protecting floor surfaces from anterior and posterior frame structures of a wheelbarrow according to the present invention includes a wheelbarrow nose protector attachable to the nose of the anterior frame structure forward of the wheel, the nose protector including a bumper constructed of a resilient material that is configured to provide a non-marring interface with the floor surface. The bumper of the nose protector may be coupled to a support via a pivot structure that enables the bumper to articulate in a rotational or tilting movement. Further, the apparatus includes a pair of sliders attachable to respective legs of the posterior frame structure, each slider including an auxiliary bumper configured to cover a bottom of each leg and constructed of a resilient material that is configured to provide a non-marring interface with the floor surface. The bumpers may be constructed using rubber, plastic, foam, or combinations thereof.

Therefore, a general object of this invention is to provide a wheelbarrow floor guard protection apparatus that includes a nose protection assembly that includes a nose pad that is configured to protect a floor or ground surface when the wheelbarrow is forward when dumping a load.

Another object of this invention is to provide a floor guard protection apparatus, as aforesaid, that includes padded slider members coupled to rear frame portion for protecting the floor when the wheelbarrow is at rest or slides.

Still another object of this invention is to provide a floor guard protection apparatus, as aforesaid, that is configured to articulate (e.g., pivot or tilt) when pivoted forwardly onto the nose pad.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of an apparatus for protecting floor surfaces from the leg frame structures of a wheelbarrow according to a preferred embodiment of the present invention, illustrated with a slider coupled to a respective posterior leg;

FIG. 1b is another perspective view of the apparatus illustrated with the slider exploded from the respective posterior leg;

FIG. 2 is a perspective view of the apparatus as in Fig. la illustrated positioned atop a floor surface;

FIG. 3 is a perspective view of the apparatus as in FIG. 2, illustrated with the wheelbarrow being tipped forward to depict the nose protector bumper in contact with the floor surface;

FIG. 4a is another perspective view of the apparatus as in FIG. 3;

FIG. 4b is an isolated view on an enlarged scale taken from FIG. 4a;

FIG. 5a is an isolated and enlarged view of the nose protector with the bumper being coupled to a support and shown in a parallel and default configuration;

FIG. 5b is another view of the nose protector as in FIG. 5a, illustrated with the bumper being rotationally articulated relative to the support;

FIG. 6a is an exploded view of the nose protector according to the present invention; and

FIG. 6b is a perspective view of a slider detached from the posterior leg of a wheelbarrow as in FIG. 1b.

### DESCRIPTION OF THE PREFERRED EMBODIMENT

Accordingly, a wheelbarrow floor guard protection apparatus 20 according to the present invention will be described in detail with reference to the accompanying drawings and attachable to a wheelbarrow 100 to enable an operator to move materials within the wheelbarrow 100 without scratching or damaging a floor or ground surface. The wheelbarrow floor guard protection apparatus 20 may include a nose protector 22 and sliders 50 that attach onto each of the wheelbarrow legs, respectively, to insulate the wheelbarrow 100 from the floor surface.

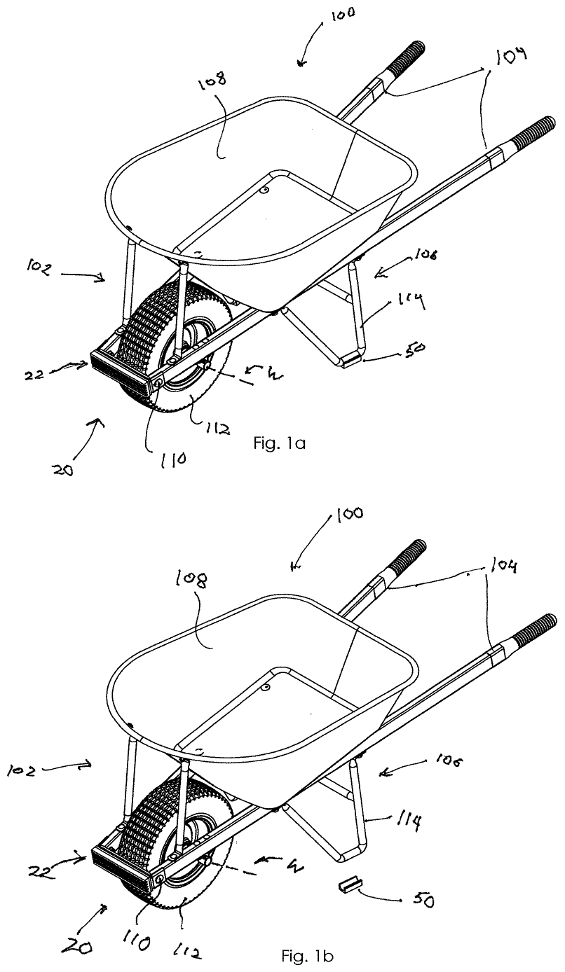

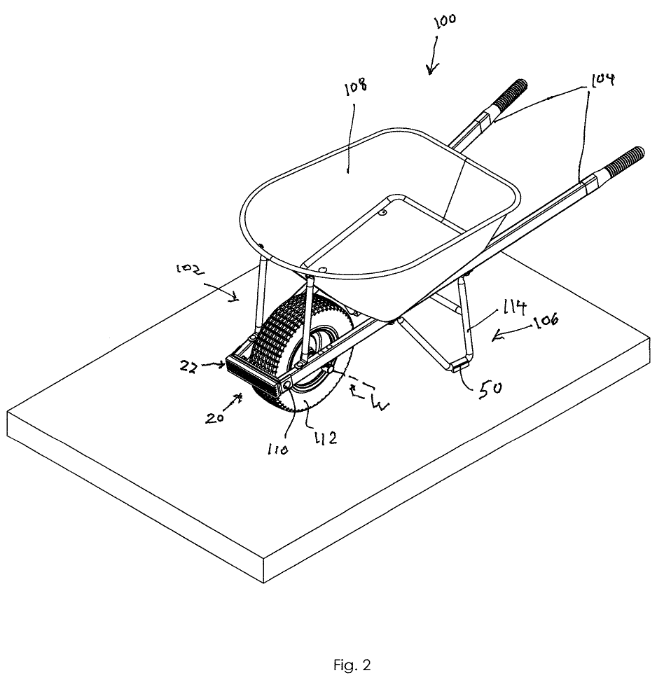

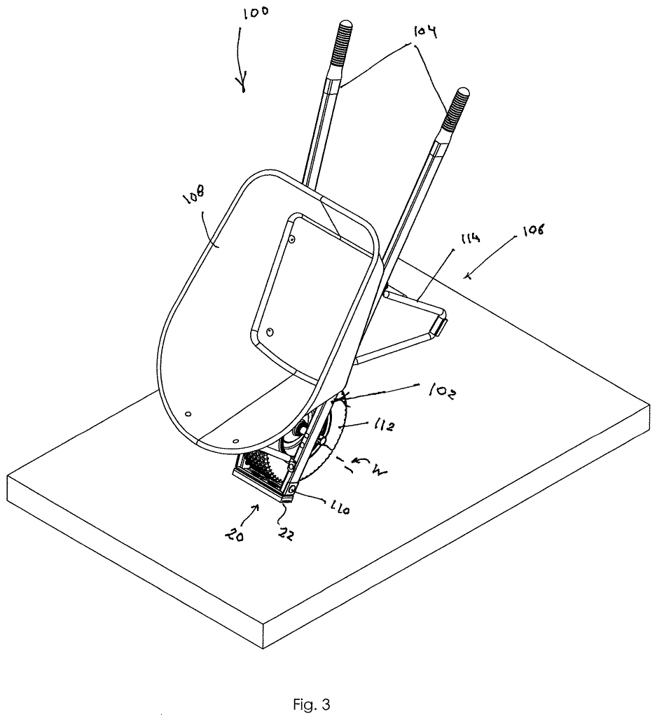

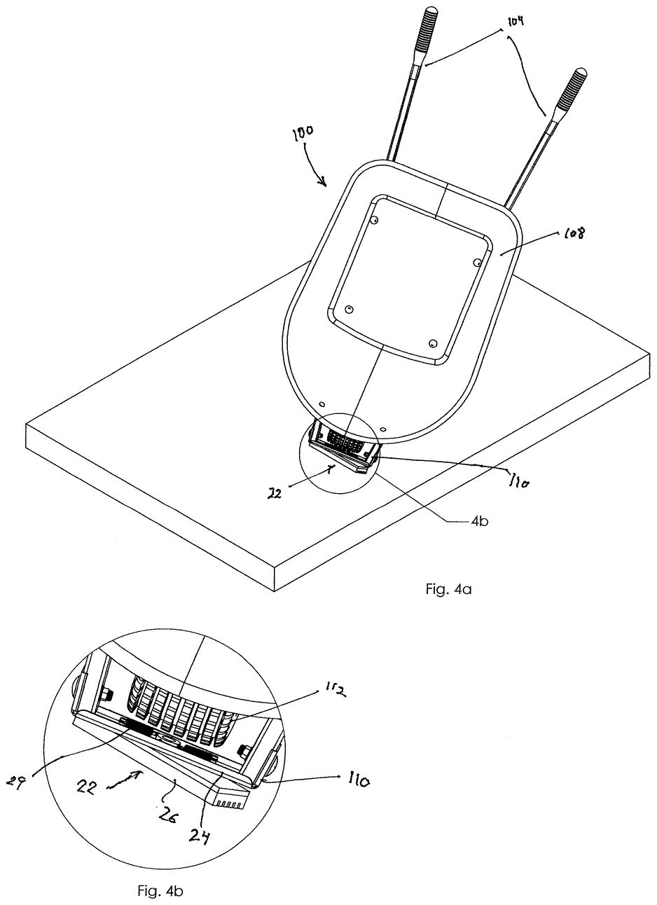

As shown in FIG. 1a, the wheelbarrow 100 generally includes an anterior structure 102, a handle structure 104, and a posterior structure 106 attached to a tray 108. The anterior structure 102 is a rolling structure that supports the tray 108 above a supporting surface. The posterior structure 106 raises the tray 108 above the supporting surface. The handle structure 104 allows a person to manipulate the wheelbarrow 100. The tray 108 may be a pan shaped structure for transporting materials.

The anterior structure 102 (i.e., the front or frontward area) generally includes a nose 110 forward of a wheel 112 that rotates about an axis W (FIG. 1a). The nose 110 is often in contact with the floor surface when the wheelbarrow 100 is tipped forward to dump the tray 108. The posterior structure 106 typically includes two legs 114 that rest upon the floor surface when the wheelbarrow 100 is not being moved by an operator. It is understood that the wheelbarrow 100 has a traditional configuration having a pair of rear legs although the accompanying illustrations may only show one rear leg.

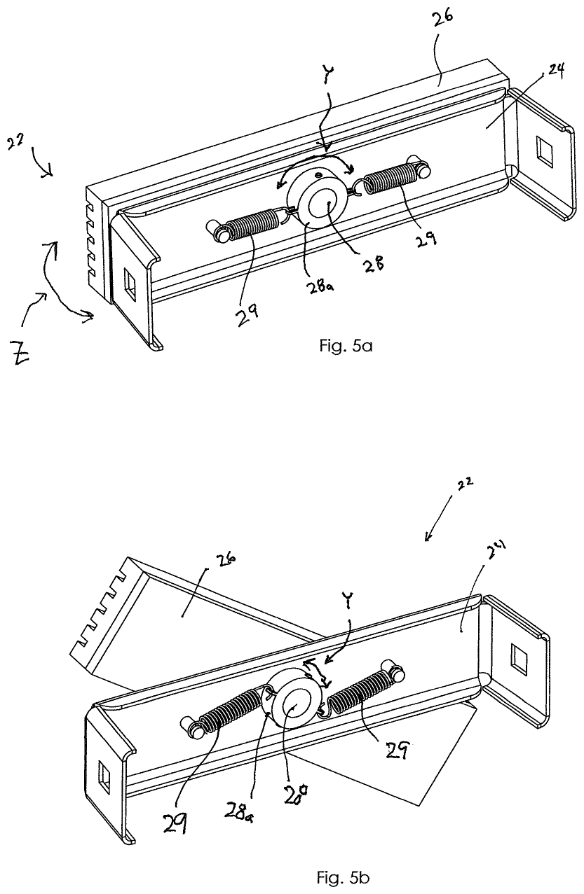

The wheelbarrow nose protector 22 includes a support 24 and a bumper 26 that is coupled to a rear surface of the support 24 and articulates with respect to the support 24 (FIG. 5a). The support 24 may be manufactured of a metal alloy, non-metallic material such as plastic, etc. The support 24 may be attached to the nose 110 in various manners, such as a friction fit, fasteners, etc. In this embodiment, the support 24 may extend transverse to the wheel 112 and parallel to a wheel axis.

The bumper 26 may be manufactured of a resilient material such as rubber, plastic, foam, etc., that would provide a non-marring interface with the floor surface. That is, the bumper 26 may provide a non-skid yet relatively soft surface that will not harm the surface upon which the wheelbarrow 100 may traverse and/or be tipped up.

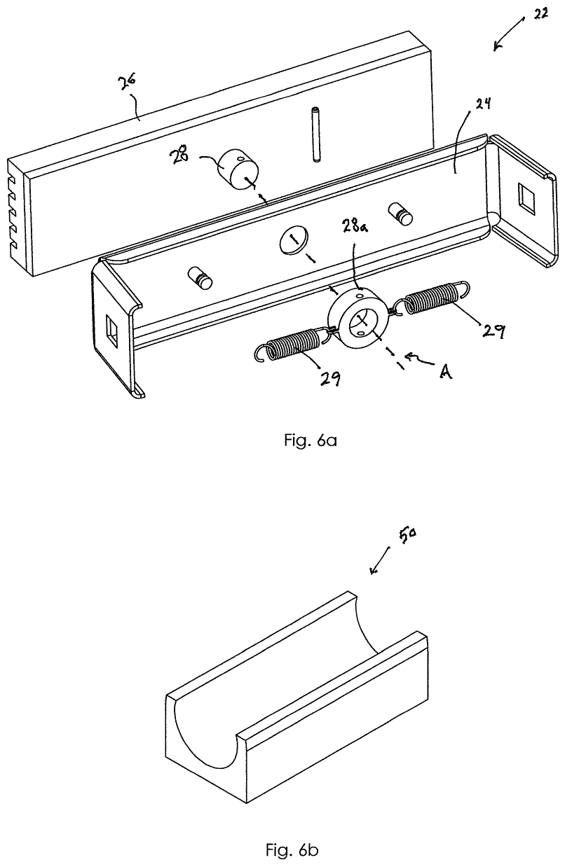

In one embodiment, the bumper 26 is mounted to a pivot structure 28 along a longitudinal axis A (FIG. 6a). The pivot structure 28 may include a pin, hinge, ball joint, etc., that extends through a hub 28a that permits the bumper to angularly rotate Y about the axis A as well as tilt as indicated at reference character Z with respect to the axis A. The bumper 26 may be biased with respect to the support 24 by a set of springs 29, such that the bumper 26 is biased toward being parallel with respect to the support 24. The pivot structure 28 may be mounted in a center section of the support 24. Stated another way, the biasing mechanism may include a pair of compression springs mounted to a rear surface of the support 24 and positioned opposite one another, said pair of springs being coupled to opposite sides of said hub 28a and being movable between (1) offset and extended configurations when said bumper is rotatably articulated relative to said support 24 (FIG. 5b) and (2) a compressed and linear configurations and when said bumper 26 is parallel with the support 24 (FIG. 5a).

The pivot structure 28 provides a freedom of movement of the bumper 26 with respect to the support 24 such as when the wheelbarrow 100 is tipped forward onto the bumper 24. The wheelbarrow 100 may thereby be rotated Y about the axis A of the pivot structure 28 as well as being movable side to side to facilitate distribution of materials from the tray 108.

That is, the pivot structure 28 may provide a universal type joint between the bumper 26 and the support 24.

The sliders 50 may each include a support 52 and a bumper 54 (for clarity, also referred to as an auxiliary bumper 54). The support 52 of each slider 50 may be manufactured of a metal alloy, non-metallic material such as plastic, etc., and may be attached to the legs 114 in various manners, such as a friction fit, fasteners, etc. The bumper 54 of each slider 50 may be manufactured of rubber, silicon, plastic, foam, etc., that provide a non-marring interface with the floor surface. The sliders 50 prevent the metal portion of the legs 114 from contacting the floor surface in motion or at rest allowing for the operator to move the wheelbarrow along any floor surface without scratching the floor surface. The sliders 50 are readily detachable to allow for different floor surfaces, e.g., indoor or outdoor. The wheelbarrow floor guard protection system 20 allows wheelbarrow 100 operators to move materials without concern of scratching or damaging the floor surface of an indoor or outdoor floor.

It is understood that while certain forms of this invention have been illustrated and described, it is not limited thereto except insofar as such limitations are included in the following claims and allowable functional equivalents thereof.

What is claimed is:

1. An apparatus for protecting floor surfaces from a wheelbarrow of a type that includes (1) an anterior frame structure having a nose and a wheel rotatable about a wheel axis and (2) a posterior frame structure having two legs, a handle structure, and a tray, the apparatus comprising:
a wheelbarrow nose protector attachable to the nose of the anterior frame structure forward of the wheel, said nose protector including a bumper constructed of a resilient material that is configured to provide a non-marring interface with the floor surface; and
a pair of sliders attachable to respective legs of the posterior frame structure, each slider including an auxiliary bumper configured to cover a bottom of each leg and constructed of a resilient material that is configured to provide a non-marring interface with the floor surface.

2. The system as in claim 1, wherein the nose protector includes:
a support coupled to the nose and that extends transverse to the wheel and parallel to the wheel axis,
the bumper being pivotally coupled to the support via a pivot structure such that said bumper is operable for rotational movement about a longitudinal axis and for tilting movement relative to the longitudinal axis.

3. The system as in claim 2, wherein said pivot structure includes a pin, hinge, or ball joint extending through a hub so as to permit angular rotation and tilting movement of said bumper.

4. The system as in claim 3, further comprising. a biasing mechanism mounted to the support operable for biasing the bumper toward a position parallel to the support.

5. The system as in claim 4, wherein said biasing mechanism includes a pair of springs mounted to a rear surface of said support and positioned opposite one another, said pair of springs being coupled to opposite sides of said hub and being movable between (1) offset and expanded configurations when said bumper is rotatably articulated relative to said support and (2) compressed configurations when said bumper is parallel with said support.

6. The system as in claim 1, wherein said each slider is detachably coupled to the bottom of said each leg of said posterior frame structure.

7. The system as in claim 6, wherein said each slider is attached to said respective leg of the posterior frame structure via a friction fit, fasteners, or a combination thereof.

8. The system as in claim 6 wherein said auxiliary bumper of said each slider includes rubber, silicone, plastic, foam, or a combination thereof.

9. A floor surface protecting apparatus for attachment to a wheelbarrow of a type that includes (1) an anterior frame structure having a nose and a wheel rotatable about a wheel axis and (2) a posterior frame structure having two legs, a handle structure, and a tray, the apparatus comprising:
a wheelbarrow nose protector attachable to the nose of the anterior frame structure forward of the wheel, said nose protector including a bumper constructed of a resilient material that is configured to provide a non-marring interface with a floor surface; and
a pair of sliders attachable to respective legs of the posterior frame structure, each slider including an auxiliary bumper configured to cover a bottom of each leg and constructed of a resilient material that is configured to provide a non-marring interface with the floor surface;
a pivot structure coupling said bumper to said support and operable to permit said bumper to rotate about a longitudinal axis,
a biasing mechanism mounted to said support and operably coupled to the bumper, said biasing mechanism being configured to bias said bumper toward a position parallel to said support.

10. The apparatus as in claim 9, wherein the support is coupled to the nose and extends transverse to the wheel and parallel to the wheel axis.

11. The apparatus as in claim 9, wherein said pivot structure includes a pin, hinge, or ball joint extending through a hub mounted on said support so as define said longitudinal axis and to permit angular rotation of said bumper relative to said support.

12. The apparatus as in claim 11, wherein said biasing mechanism includes a pair of springs mounted to a rear surface of said support and positioned opposite one another, said pair of springs being coupled to opposite sides of said hub and being movable between (1) offset and expanded configurations when said bumper is rotatably articulated relative to said support and (2) compressed configurations when said bumper is parallel with said support.

13. The apparatus as in claim 9, wherein said each slider is detachably coupled to the bottom of said each leg of said posterior frame structure.

14. The apparatus as in claim 9, wherein said each slider is attached to said respective leg of the posterior frame structure via a friction fit, fasteners, or a combination thereof.

15. The apparatus as in claim 9 wherein said auxiliary bumper of said each slider includes rubber, silicone, plastic, foam, or a combination thereof.
